(19) United States
(12) Patent Application Publication
(10) Pub. No.: US 2014/0269920 A1
(43) Pub. Date: Sep. 18, 2014

(54) Motion Estimation Guidance in Transcoding Operation

(71) Applicant: Cisco Technology, Inc., San Jose, CA (US)

(72) Inventors: Arturo A. Rodriguez, Norcross, GA (US); Ryan Pabis, Finleyville, PA (US)

(21) Appl. No.: 13/844,625

(22) Filed: Mar. 15, 2013

(51) Int. Cl. H04N 7/26; H04N 7/36

(52) U.S. Cl. CPC H04N 19/00472; H04N 19/00587
USPC 375/240.16; 375/240.12

(57) ABSTRACT

In one embodiment, a transcoding system, comprising: a memory encoded with logic; and a processor configured to execute the logic to, dependent on a defined operation of the system, either perform a first set of steps of a motion estimation operation using one or more reference pictures of a picture sequence input to the system, or perform the first set of steps of the motion estimation operation using one or more decompressed versions of the inputted picture sequence.

### TECHNICAL FIELD

The present disclosure relates generally to video transcoding.

### BACKGROUND

Compressed video is in common use for such applications as distribution of video to consumers via cable or satellite, videoconferencing, distribution of video material on media such as DVD, and so forth. Over time, compression formats have become more and more efficient. However, as new compression formats are invented and implemented, both content and infrastructure remains for video in the older formats. For example, MPEG-2 Video is one of several popular compression methods used to encode video. There is much material available encoded in MPEG-2 Video and MPEG-4 AVC, and furthermore, much infrastructure exists for video encoded in existing video coding specifications.

In the last few years, more advanced video compression formats and associated compression methods have been developed and are being deployed. ITU-T H.264/AVC, also called MPEG-4 part 10, and hereinafter referred to as H.264 is one such standard method. The Chinese AVS is another such standard. The SMPTE 421M video coding/decoding (codec) standard, also known as VC-1 is yet another video coding standard. Many coding methods use motion estimation and compensation to take into account that there may be parts of a picture that move from one instance of time to another to frame. Motion estimation determines the translational displacement of a block being coded to similar information in a reference picture, results in a reduction of the amount of information that needs to be used to represent a picture in its compressed form of a video stream. Motion estimation is typically the most compute-intensive part of an encoding process. When designing a transcoding process and an apparatus therefore, there is advantage to be gained by making the transcoding process efficient and limiting degradation.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 shows a high-level block diagram illustrating an example video distribution system that may include one or more transcoding system embodiments.

FIG. 2 shows a simplified block diagram illustrating an embodiment of an example transcoding system.

FIGS. 3-5 are flow diagrams that illustrate several transcoding method embodiments.

### DESCRIPTION OF EXAMPLE EMBODIMENTS

### Overview

In one embodiment, a transcoding system, comprising: a memory encoded with logic; and a processor configured to execute the logic to, dependent on a defined operation of the system, either perform a first set of steps of a motion estimation operation using one or more reference pictures of a picture sequence input to the system, or perform the first set of steps of the motion estimation operation using one or more decompressed versions of the inputted picture sequence.

### Example Embodiments

Disclosed herein are certain embodiments of transcoding systems and methods (herein, collectively transcoding system or transcoding systems). In one embodiment, the transcoding system comprises functionality to perform spatial and/or temporal prediction to attain compression of one or more pictures of a picture sequence corresponding to a video signal provided in compressed form (e.g., coded video stream), such that the video stream is decoded according to a first compressed video format and thereafter encoded according to a second compressed video format, to perform a conversion or transcode operation from the first to the second video format, such as when transcoding a video stream coded according to MPEG-2 Video, and transcoding to AVC. The transcoding system comprises a decompression engine and a compression engine (herein interchangeably referred to as decoder and encoder, respectively). The encoder functions according to a programmed or designed coding strategy and uses only luma information to perform at least a portion of the prediction operations, some which are temporal prediction operations (e.g., motion estimation based) and others which are intra prediction operations (within the same picture being coded). Motion Estimation is typically the most resource consuming and most compute intensive portion of video coding. Therefore, an encoder tends to use luma information in motion estimation operations (i.e., while performing temporal prediction). The use of luma information refers to the use of luma pixels (or samples) for both, the predictor and the block in the picture been coded, to find the best predictor among a set of candidate predictors. In an intra coded picture, all the candidate predictors are derived from luma pixels already processed, such as pixels above and to the left of the block being coded. In non-intra pictures, there are a substantial higher number of additional candidate predictors corresponding respectively to one or more temporal candidate predictors derived from one or more motion vectors that correspond to one or more reference pictures.

In one embodiment, the compression engine uses luma information to perform prediction operations to find the best predictor while encoding the uncompressed pictures of a picture sequence that was not previously compressed but uses both, luma and chroma information, to perform prediction operations to find the best predictor while encoding the uncompressed pictures of a picture sequence that was previously compressed in a first video compression format, such as when transcoding from a first to a second video compression format. The compression engine strategy is changed from normal (only using luma information) when the input video has undergone one or more iterations of compression followed by decompression, such that the spatial and/or temporal prediction operations are guided or enforced to use chroma information in some or all of the phases of the prediction process. In some transcoding system embodiments (in addition to, or in lieu of the functionality described above), the compression engine is configured to find the best prediction from the input pictures rather than the reconstructed reference pictures it produces. In an alternate embodiment, the input pictures are used but for the last phase of the prediction. In yet another embodiment, the input pictures are used only for temporal prediction operations but not for the intra prediction operations (i.e., intra prediction operations are performed with reconstructed samples. Benefits of one or more of the above approaches may include improvement in chroma PSNR and/or less quantization or contouring artifacts when compared to conventional approaches.

In one embodiment, transcoding a video stream from a first to a second compression format corresponds to a decompression operation performed by decompression engine 203 (FIG. 2) to decode the video stream in accordance to the syntax and semantics a first video coding specification, followed by compression operation performed by compression engine 205 (FIG. 2) to encode the video stream in accordance to the syntax and semantics a second video coding specification, wherein the second video coding specification is different than the first video coding specification. In an alternate embodiment, the transcoding from a first to a second video compression format respectively correspond to a first and second spatial location of the chroma samples in each picture, in which the first and second respective spatial locations of the chroma samples in the picture are different in relation to the location of the luma samples in the picture. In yet, another embodiment, the transcode operation from a first to a second compressed video format comprises of using the same video coding specification but changing the characteristics of the video stream, such as re-encode operation to reduce the bit-rate of the video stream. Alternatively, the frame rate of the video stream may be reduced. Yet in another embodiment, the transcode operation may be performed to convert the pictures in the video stream from an interlaced scan format to a progressive scan format, such as assisted by a de-interlacer operation that converts successive coded fields to progressive frames.

Digressing briefly, in an encoder processing pipeline, temporally predicted pictures are encoded using motion estimation to exploit temporal redundancy. Each of plural blocks in the picture to be encoded is compared to same size blocks in a search space of one or more reference pictures while performing motion estimation. Each block comparison constitutes a predictor in the reference picture that corresponds to the translational offset corresponding to a motion vector in relation to the location of the block being encoded. In an alternate embodiment, in addition to performing motion estimation for plural block in the picture, each of the sub-blocks in a set of non-overlapping sub-blocks that span the entire block and do not extend beyond the block boundaries, referred herein to as a sub-blocks partition, undergoes the motion estimation operation. In another embodiment, all the sub-blocks in a sub-blocks partition are square and have the same size. In an alternate embodiment, a portion of the sub-block partitions are square but not all squared sub-blocks have the same size. (i.e., they are sub-divided inside quadrants). In yet another embodiment, a first set of the plural sub-blocks partitions contain only square sub-blocks and the remaining set of sub-blocks partitions that undergo motion estimation contain only rectangular sub-blocks that are not squares but all of the rectangular (non-square) sub-blocks have a common size. In yet another embodiment, a first set of the plural partitions contain only square sub-blocks partitions, a second set of partitions contain rectangular (non-square) sub-blocks with a common rectangular size, and a third set of sub-block partitions, corresponding to the remaining set of sub-blocks partitions, are all rectangular sub-blocks but at least one of the rectangular sub-blocks has a different size.

For motion estimation purposes, the reference pictures are typically the version of the reference pictures that have been processed, compressed and decompressed (reconstructed) by the encoder, because the reconstructed version is what a decoder is able to reconstruct while performing decompression of the video stream in a first video compression format. That is, remote decoders will not have access the pictures that were input to the encoder (i.e., that is the whole purpose of video compression—to avoid transmitting copious data that results in an excessive amount of bandwidth). The reference picture reconstruction at the encoder is performed in the portion of the encoder that emulates the decoder.

In one embodiment, an encoder receives at its input a sequence of pictures corresponding to a video signal that was previously never compressed, and a second sequence of uncompressed pictures but that were decompressed from a video stream in accordance to a first video compression format. During an encoding operation by compression engine 205, in wherein compression engine 205 is configured to encode the input picture sequence as not previously compressed, the encoder uses the reconstructed (decompressed) version of reference pictures during motion estimation. In an alternate embodiment, the compression engine 205 is configured to use the reference pictures during motion estimation when the input sequence was not previously compressed or previously compressed but at a bit-rate that is sufficiently high, such as above a respective predetermined bit-rate threshold that corresponds to the picture resolution and frame rate of the input picture sequence. During an encoding operation when compression engine 205 is not configured to use reference pictures during motion estimation, such as when encoding of a sequence of pictures previously decompressed from a video stream or a decoded video stream that did not have a sufficiently high bit-rate, the version of the input pictures to the encoder are used for reference pictures during the motion estimation rather than the reconstructed (decompressed) version that the encoder produces for the respective input pictures. The reconstructed references pictures are always used by the encoder to perform motion compensation to obtain properly encode the residual signal that results from the difference between the block being coded and the derived predictor from the reconstructed reference pictures. In one embodiment, the encoder 205 uses the version of input picture as reference pictures throughout integer motion estimation but employs their reconstructed version to perform sub-pixel precision in the last phase of motion estimation.

Before addressing certain transcoding system embodiments, a brief overview of the various terms used herein is in order. The terms video coding and video compression are used herein interchangeably. Video coding methods work by exploiting data redundancy in a sequence of digitized pictures. There are two types of redundancies in a video sequence, namely, spatial and temporal. Video coding exploits the correlation that exists between successive pictures (e.g., temporal redundancy) and correlation that exists spatially within a single picture (e.g., spatial redundancy). For instance, in motion pictures, there may be one or more parts of a picture that appears in a translated form in successive pictures (e.g., there may be one or more parts that move in the video sequence). Compression methods are motion compensated in that they include determining motion (so called motion estimation) of one or more elements (e.g., a block), and compensating for the motion (so called motion compensation) before exploiting any temporal redundancy.

As previously described Motion estimation may be applied at a block only in one embodiment. In an alternate embodiments motion estimation may be further applied at a sub-block level according to sub-blocks partitions, which further increases the amount of computation required and the amount of resources consumed (such as memory bus bandwidth consumption). Block-based and sub-block-based motion estimation and compensation techniques typically assume translational motion. In AVC, for instance, redundancies are typically removed by predicting block data, both spatially and temporally. MPEG-2, on the other hand, does not employ spatial prediction when a macroblock is encoded as intra but merely decorrelates the data by employment of a discrete cosine transform. Lossy compression includes some loss of accuracy in a manner that may not be perceptible. Once the temporal and/or spatial redundancy is removed, and some information is removed, some further compression is obtained by losslessly encoding the resulting lossy information in a manner that reduces the average length of codewords, including encoding values that are more likely to occur by shorter codes than values that are less likely to occur.

Compression methods involve dividing each two dimensional (2-D) picture into smaller non-overlapping rectangular regions, such as macroblocks, which are square block. IN some video coding specifications, a macroblock is coded with a common coding mode (i.e., type of prediction) but may be subdivided into a sub-blocks partition for prediction purposes. In an alternate embodiment, a block (such as a macroblock) may be sub-divided, such as by quadtree decomposition, and each leaf of the quadtree may be coded with a respective coding mode. Prediction (such as motion estimation) is performed on the leaf blocks or sub-blocks partitions of the leaf nodes. In AVC, temporal prediction (e.g., motion estimation) involves finding a combination of sub-blocks belonging to one of the allowed sub-block partitions in a reference picture or a combination of reference pictures that serves to predict the data in a current macroblock. Matching criteria is used to find and derive the best predictor from one or more candidate predictor among the set many candidate predictors from one or more reference pictures. Spatial prediction in AVC involves forming predictors from data in neighboring macroblocks that have undergone encoding. Matching criteria is used to find and derive the best predictor among the set of spatial predictors. Motion estimation entails finding the best set of block predictors in a search space in one or more reference pictures. A predictor of a to-be-encoded block refers to a block in a reference picture deemed to be a best match (according to matching criteria) to the values of the pixels in the current block. A block can have a predictor derived from more than one predictor in more than one respective reference picture. Stated differently, many candidate blocks and combinations of blocks serve to predict the current block or sub-block at many or possibly all pixel offsets in the search space of each of one or more reference pictures. By a search space is meant the portion of a reference picture relative to the location of a block that is processed by a motion estimation operation to derive a predictor. A block can also have a predictor derived from two predictors in different search spaces within the same reference picture.

For a to-be-coded block, motion estimation determines a “match” in one or more reference pictures to determine the displacement between the to-be-coded block in a to-be-coded picture to a “matched” block in the one or more reference pictures. Matching is according to one or more matching criteria. Block matching criteria, such as the Sum of Pixel Absolute Errors and the Sum of the Squared Pixel Errors, is used to find the best match among all candidate blocks and combinations of blocks. Each displacement is represented by a so called motion vector. Motion vectors typically are losslessly encoded and sent to the decoder, as is information used to determine the motion compensated data to enable reconstruction of blocks at the decoder.

During reconstruction, a decoder uses information in the video stream to derive the one or more motion vectors used to in turn derive the predictor, which is typically added to a derived residual signal (from information in the video stream) reconstruct the block or sub-block. Information in one of more reference pictures known at the decoder serves to predict the pixel values in one or more blocks of the picture being decompressed. A reference picture refers to a picture that at the encoder can be assumed to be known at the matching decoder, by previously receiving and decoding the coded picture used as the reference picture. A reference picture may either have a previous output picture time or a future picture output time.

As used herein, digital video includes a sequence of digital pictures. Each picture includes a set of picture elements (pixels), and each pixel include includes color, so may have multiple components. In one form of color encoding, each pixel includes red, green, and blue components. Alternately, each pixel may be described in another color space that separates monochromatic brightness information related to luma from two components representative of color only. In the detailed description herein, the brightness information is called luma, and denoted Y′, and includes gamma correction (hence the prime), and color information in the form of chroma components denoted Cb and Cr, that each provide color difference information respectively related to gamma-corrected blue with luma removed, and gamma corrected red with luma removed. The three components are thus Y′, Cb, and Cr. Those having ordinary skill in the art should understand that other color representations are possible, and that alternate embodiments of the present disclosure may apply to such other color representations.

Each picture can be thought of a 2-D array of pixels. Each pixel has three components, e.g., Y′, Cb, Cr. Because it is known that the human visual system is less sensitive to spatial variation of only color than to spatial variations of brightness, in many video compression methods, chroma is compressed at a lower resolution than the luma signal. Therefore, the luma is the highest resolution, and the chroma in the smaller 2-D resolution can be either shared among neighboring pixels or, as necessary, their values can be upscaled, e.g., using upscaling spatial filters to the 2-D resolution of the Y′ component that typically defines the resolution of the picture.

A “picture” is often referred to as a “frame.” In non-interlaced implementations, so-called progressive video, a frame is a full picture at full resolution associated with a single instance of time. In interlaced video, a frame is made up of two fields of different lines of a picture, each field corresponding to an instance in time, so that when the fields are combined, a full frame is obtained. xxx2:1 interlaced video is common in which each field includes alternate lines. For example, if a frame is made up of lines numbered 1-1080, then one frame includes the lines numbered 1, 3, . . . , 1079, and the other frame includes the lines numbered xxx2, 4, . . . , 1080. In the description that follows, a picture and a frame will be used interchangeably.

FIG. 1 shows a high-level block diagram illustrating an example video distribution system 100 that may include one or more embodiments of a transcoding system. The example video distribution system 100 includes a headend 101 and a set-top unit 105 that are coupled via a network 103. The transcoding system 200 is depicted as residing in the headend 101 (200A) and the set-top unit 105 (200B), though it should be appreciated that in some embodiments the transcoding system 200 may reside in only one of these locales or in some embodiments, elsewhere in the system 100. The set-top unit 105 is typically situated at a user's residence or place of business and can be a stand-alone unit or integrated into another device, such as, but not limited to, a display device 107 such as a television display or a computer display, a device with integrated display capability such as a portable video player, and/or a personal computer. Other video applications include video conferencing, telephone networks, and simply viewing pre-recoded video programs that are recorded in a first video compression format and that are to be converted to a second video compression format.

The set-top unit 105 is configured to receive one or more video programs that include their respective video, audio and/or other data portions, as analog or digital signals and/or digitally-compressed (i.e., digitized and compressed) signals. For instance, the set-top unit 105 is configured to receive from the headend 101 a compressed video stream according to the syntax and semantics of a video coding specification (e.g., MPEG-2, AVC, etc.). In one embodiment, the compressed video stream is modulated on a carrier signal, among others, from the headend 101 through the network 103 to set-top unit 105. In some applications, the set-top unit 105 provides reverse information to the headend 101 through the network 103. Additionally or alternatively, the set-top unit 105 can receive video signals from a locally coupled consumer electronics device such as a video player or camcorder, the video signal comprising an analog, digital, and/or digitally-compressed signal.

Storage requirements in a device, such as a PVR-equipped set-top unit, can be reduced by the transcoding system 200B transcoding programs received from an analog or digital channel or digitally-compressed (e.g., MPEG-2) channels from one format to another format (e.g., different bit rate MPEG-2 or AVC). The savings in storage apply not only to HD programs but to SD programs as well. Encoding programs from analog channels with a superior compression format further reduces storage requirements. Real-time transcoding of MPEG-2 SD programs to AVC is economically feasible today, and real-time HD transcoding operations should be, if not already, economically feasible as higher throughput devices and faster memories become available.

The network 103 may include any suitable mechanism for communicating television data including, for example, a cable television network, a satellite television network, and/or terrestrial network, among others. The headend 101 and the set-top unit 105 cooperate to provide a user with television functionality including, for example, viewing of distributed video programs, of an interactive program guide, and/or of video-on-demand (VOD) services for viewing video programs over a dedicated transmission to the user. The headend 101 and the set-top unit 105 also may cooperate to provide authorization signals or messages via the network 103 that enable the set-top unit 105 to perform one or more particular functions that are pre-defined to require authorization.

Details of the headend 101, outside of the transcoding system 200A, are not shown in FIG. 1. Those having ordinary skill in the art should appreciate that a headend 101 can include one or more server devices for providing video programs, connections to other distribution networks with a mechanism to receive one or more programs via the other distribution networks, other media such as audio programs, and textual data to client devices such as set-top unit 105. The transcoding system 200A may receive a picture sequence corresponding to a video signal, where the received picture sequence comprises an analog signal, a digitized signal where the associated picture sequence has not yet been subject to a video compression process, a decompressed signal, or a compressed signal.

Although shown with transcoding system 200A and 200B residing in the headend 101 and the set-top unit 105, emphasis is placed on the headend locale for the transcoding system 200A, with the understanding that similar principles apply to the set-top unit locale or other locales within the system 100. The transcoding system 200A or 200B will hereinafter be denoted as simply transcoding system 200 for simplicity. While it is understood that the headend 101 is configured to receive one or more video programs that include their respective video, audio and/or other data portions (e.g., as digital, digitally-compressed, or analog signals), for simplicity, the disclosure herein concentrates on the video portion of a program.

FIG. 2 shows one embodiment of transcoding system 200. Note that the architecture of the transcoding system 200 shown in FIG. 2 is merely illustrative and should not be construed as implying any limitations upon the scope of the disclosed embodiments. For instance, in some embodiments, a local storage device (e.g., local hard drive) may be utilized as well, particularly for set-top unit applications. In the embodiment depicted in FIG. 2, the transcoding system 200 includes a decompression engine 203 (herein, also decoder) and a compression engine 205. Also included is a processing system in the form of one or more processors 209 and a memory subsystem 207. The memory subsystem 207 includes executable instructions, shown as programs 225 that instruct the processor in combination with the decompression and compression engines to carry out the transcoding, including one or more transcoding method embodiments of the present disclosure. In one embodiment, the executable instructions may be embodied as software and/or firmware (e.g., executable instructions) encoded on a tangible (e.g., non-transitory) computer readable medium such as memory 207.

In one embodiment, the decompression engine 203 is configured to decompress data received in a first format (e.g., MPEG-2), while the compression engine 205 is configured to compress data into a second compression format (e.g., H.264, MPEG-2 at a different bit rate, etc). Each of the compression engine 205 and the decompression engine 203 has a respective media memory 221 and 223 in which media information is storable and from which media information is retrievable. In one embodiment, the media memory 221 of the decompression engine 203 and the media memory 223 of the compression engine 205 are in the memory subsystem 207. In an alternate embodiment, these are separate memory elements. In one such alternate embodiment, there is a direct link between the media memory 223 of the decompression engine 203 and the media memory 221 of the compression engine 205.

A video program embodied as a plurality of pictures of a picture sequence is received by the transcoder 200 at the input 231 to the transcoding system 200. As set forth above, the video program 231 may be received in a digitally-compressed format (e.g., MPEG-2). In some implementations, the video program may be embodied in an analog video signal (which in such embodiments, the transcoder may include, or be coupled to, an analog video decoder) or digitized video signal, the plurality of pictures not yet subject to a compression process. For instance, the previously never compressed video signal may be in a 4:2:2 (Y′, Cb, Cr) picture format. In some implementations, the video program may be embodied as a plurality of pictures of a decompressed video stream (i.e., previously compressed), such as in a 4:2:0 picture format. For an MPEG-2 compressed video stream received as input, the video program may be received as input 231 to the decompression engine 203. The decompression engine 203 receives the video and audio streams (e.g., from a network, from a storage device, etc.). The decompression engine 203 is operative to store the input video program in a portion of a media memory 223, where it can then be retrieved for decompression. The decompression engine 203 is operative to process the video in the first received format, including to extract auxiliary information (e.g., as one or more auxiliary data elements from the video) and also to decompress (when received as a compressed video stream) the video to a sequence of decompressed pictures. The processing by the decompression engine 203 is according to the syntax and semantics of the first video compression format (e.g., MPEG-2 video), while reading and writing data to media memory 223.

In one embodiment, the decompression engine 203 is operative to output the extracted auxiliary data elements and the decompressed and reconstructed sequence of pictures to the compression engine 205 through a direct interface. In one embodiment, additionally or as an alternate, the decompression engine 203 outputs the auxiliary data elements to its media memory 221. Data transfers are then conducted to transfer the auxiliary data elements from media memory 221 to compression engine's 205 media memory 223. In one version, media memories 221 and 223 are part of the memory subsystem 207 and thus each of the decompression engine 203 and the compression engine 205 can access the contents of each of the media memories.

The compression engine 205 produces the video stream, audio stream, and associated data with the video program in a multiplexed transport or program stream. The compression engine 205 reads and writes data from media memory 223 while performing all of its compression and processing operations and outputs the multiplexed stream through a direct interface to a processing system 209 such as a digital signal processor. In one embodiment, the processing system 209 causes the multiplexed transport or program stream in the second compression format (e.g., H.264) to be provided as an output 233 of the transcoder 200.

In a transcoding operation, the video signal at the input 231 differs from the video signal at the output 233 by one or more of the following: codec format, picture resolution (e.g., which implies a video codec “Level” in video coding specifications), frame rate, bit rate (e.g., usually lower for the output 233), and codec profile (e.g., from 1920×1088 (HD) to 176×144 (QCIF)).

As described in more detail below, the transcoding may be guided by one or more auxiliary data elements. In particular, the motion estimation used by the compression engine 205 to generate a video stream at the output 233 may be guided by the auxiliary data elements.

Having described example components of the transcoding system 200, attention is directed to the flow diagrams of FIGS. 3-5, which illustrate various transcoding methodologies employed by certain embodiments of the transcoding system 200. Before proceeding with the description associated with the flow diagrams of FIGS. 3-5, a brief digression follows that provides a general overview of one or more embodiments of transcoding systems 200. With regard to processing of chroma and/or luma information and block prediction, compression engines typically makes predictions based on luma information only. Once a decision for a best prediction is made, the corresponding chroma information is thereafter encoded. Under normal operation, prediction on luma has traditionally been sufficient and effective in video compression. Employment of chroma information in the prediction process may impose a 50 percent computational burden on what already is the most compute-intensive operation in the encoding process (i.e., motion estimation and spatial prediction). Employment of luma is sufficient for making a best prediction decision when inputting digitized (yet to be subject to a compression process) pictures. But simulations have shown that when the input video has undergone one or more iterations of compression and decompression (e.g., transcoding), inclusion of chroma to find the best prediction results in higher retention of picture fidelity.

In one embodiment, the compression engine 205 includes chroma information in the prediction process. Note that, although the methodology described below is in the context of AVC, the disclosed embodiments of the transcoding system 200 are not limited to AVC. Rather, certain method embodiments of the transcoding system 200 may be applied, and hence beneficial, to any transcode operation regardless of compression format. For instance, a transcode operation from and to the same compression format may also benefit. Based on the bit-rate and other pertinent information of the incoming compressed video, the compression engine 205 is guided to use the input pictures in the prediction process and/or to use chroma information in the later phases of the prediction process.

As previously stated, the compression engine 205 exploits temporal redundancies by predicting block data in the picture that is undergoing encoding (e.g., the current picture) from the data in one or more reference pictures. At the point in time that the compression engine 205 is compressing the current picture, such reference pictures have already been compressed and possibly transmitted. However, since those pictures are destined to be used as reference pictures for the compression of subsequent pictures, while the compression engine 205 is compressing such reference pictures, it reconstructs and retains them in memory 207 so that it can later retrieve them and use them as reference pictures. By reconstructing the compressed reference pictures in memory 207, the compression engine 205 simulates a compliant decoder engine. This is because a decoder engine would not have access to the original pictures but only to their reconstructed versions that inherently exhibit signal loss (i.e., degradation) as a result of compression.

AVC possesses many more macroblock prediction alternatives than MPEG-2 video. The process of finding the best spatial predictor or best set of predictors for the current block undergoing compression in the current picture typically entails luma information only. Thus in AVC, the compression engine 205 must also keep parts of the reconstructed version of the current picture that has already undergone compression in macroblock raster order for the purpose of spatial macroblock prediction.

In one embodiment, the normal compression strategy, NS1, of the compression engine 205, finds spatial and temporal predictions from reconstructed reference pictures. In another embodiment, the normal compression strategy, NS2, of the compression engine 205 finds spatial predictions from reconstructed reference pictures but uses the input pictures for temporal predictions throughout some of the motion estimation phases. Note that the input pictures are digitized pictures (e.g., original digitized pictures, such as previously not compressed) compared to pictures of video that have undergone one or more iterations of compression and decompression.

Motion estimation phases span prediction in different pixel resolutions. For instance, motion estimation may start with a prediction phase at two-pixel resolution to find a best prediction, then proceed to a one-pixel resolution phase, followed by a half-pixel resolution phase and then quarter-pixel resolution phase.

When performing a transcode operation, the compression engine 205 is guided to use input pictures and chroma information for prediction. The level of guidance depends on whether the transcode operation is real-time or non-real-time.

Information used to guide the prediction process during the encode phase of a transcode operation includes: bit-rate of the incoming compressed video, picture size, picture type (e.g., I, P, B), compressed picture size versus the average bit-rate, relative amount of motion in a macroblock, macroblock compressed mode and level of quantization. The number of transcode operations endured by the input video is also useful and employed if known. A non-real-time transcode operation benefits from more comprehensive usage of the set of information to guide the spatial and temporal predication process.

In one embodiment, the normal compression strategy of the compression engine 205 is not invoked when the compression engine 205 is signaled that the input video has undergone prior compression. Rather, a modified compression strategy is employed by the compression engine 205 and chroma information is used in the prediction process. In one embodiment, chroma information is used in the process of finding the best spatial predictor and in the latter phases of motion estimation. In some embodiments, chroma information is used in all prediction phases. In some embodiments, chroma information is used in the sub-pel motion estimation phases only. In some embodiments, when to use chroma information in the prediction process is determined from the input information (e.g., bit-rate). In some embodiments, if the normal coding strategy is NS1, the compression engine 205 employs input pictures in both spatial and temporal predictions. If the coding strategy of the compression engine 205 is NS2, it is guided to use input pictures in spatial predictions as well. Accordingly, certain embodiments of the transcoding system 200 employ one or more of the following strategies spatial and/or temporal prediction strategies:

A. Using original pictures rather than reconstructed pictures to find the best spatial predictor.

B. Using chroma information and luma information, rather than just luma information, for finding best spatial predictor.

C. Using both A & B.

D. Using A and/or B upon info notifying the compression engine 205 that the input picture has been encoded previously at least once.

E. Using A and/or B upon info notifying the compression engine 205 that the input picture has been encoded previously n times, where n is an integer number >1.

F. Using A and/or B in motion estimation, according to:
(1) the number of times that the input picture was previously encoded; and/or
(2) information on the expected amount of degradation that the input picture has previously endured.

G. Performing one or more of the above based on using or favoring certain encoder tools in the suite of encoding methods that are known to provide better compression performance and/or picture quality retention when the compression engine 205 is signaled or informed that the input picture was previously compressed or contains degradation.

H. Performing one or more of the above based on input bit-rate or output bit-rate.

I. Performing one or more of the above based on a prior compressed format and/or compression format to be produced.

In view of the description above, it should be appreciated within the context of the present disclosure that one method embodiment, shown in FIG. 3 and denoted method 200-1, comprises the transcoding system 200 performing a first set of steps of a motion estimation operation using one or more reference pictures of a picture sequence input to a compression engine (302), or performing the first set of steps of the motion estimation operation using one or more decompressed versions of the inputted picture sequence (304).

Another method embodiment, shown in FIG. 4 and denoted method 200-2, comprises the transcoding system 200 receiving a picture sequence of a video stream and auxiliary information corresponding to the picture sequence (402); and performing the block prediction from one or more reference pictures of the picture sequence based on luma information, in the absence of chroma information, of the one or more reference pictures if the auxiliary information comprises a first value, otherwise performing the block prediction based on the chroma and luma information (404). For instance, the compression engine 205 uses the input auxiliary information conveying that the input pictures correspond to previously compressed video, and additional auxiliary information retained while decoding the prior compressed version of the video, such as motion vector of each corresponding macroblock and the quantization amount of each corresponding macroblock, to enforce chroma information usage in the motion estimation operations, hence exploiting the auxiliary info retained from the previously compressed video. For instance, a motion vector may be used to reduce the search space in the motion estimation phase of the encoding operation significantly enough to mitigate the added computation for chroma information in the matching criteria.

Yet another method embodiment, shown in FIG. 5 and denoted method 200-3, comprising the transcoding system 200 performing one or more phases of block prediction based on either an inputted version of a reference picture or a decompressed version of the reference picture, the choice of which version to use based on whether auxiliary information conveys that the picture sequence associated with the reference picture has been previously compressed (502), and optionally performing the one or more phases of block prediction based on luma information without chroma information or a combination of the luma and chroma information, the choice of using the luma only or the chroma and luma based on the auxiliary information (504).

In some embodiments, functionality associated with the transcoding system 200, in whole or in part, may be implemented in hardware logic. Hardware implementations include, but are not limited to, a programmable logic device (PLD), a programmable gate array (PGA), a field programmable gate array (FPGA), an application-specific integrated circuit (ASIC), a system on chip (SoC), and a system in package (SiP). In some embodiments, one or more functionality associated with the transcoding system 200 may be implemented as a combination of hardware logic and processor-executable instructions (software and/or firmware logic). It should be understood by one having ordinary skill in the art, in the context of the present disclosure, that in some embodiments, one or more functionality of the transcoding system 200 may be distributed among several devices, co-located or located remote from each other.

Any software components illustrated herein are abstractions chosen to illustrate how functionality may be partitioned among components in some embodiments of the transcoding systems 200 disclosed herein. Other divisions of functionality are also possible, and these other possibilities are intended to be within the scope of this disclosure. To the extent that systems and methods are described in object-oriented terms, there is no requirement that the disclosed systems and methods be implemented in an object-oriented language. Rather, the systems and methods can be implemented in any programming language, and executed on any hardware platform. Any software components referred to herein include executable code that may be packaged, for example, as a standalone executable file, a library, a shared library, a loadable module, a driver, or an assembly, as well as interpreted code that is packaged, for example, as a class.

The flow diagrams herein provide examples of the operation of the transcoding systems and methods. Blocks in these diagrams represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved.

The foregoing description of illustrated embodiments of the present disclosure, including what is described in the abstract, is not intended to be exhaustive or to limit the disclosure to the precise forms disclosed herein. While specific embodiments of, and examples for, the disclosure are described herein for illustrative purposes only, various equivalent modifications are possible within the spirit and scope of the present disclosure, as those skilled in the relevant art will recognize and appreciate. As indicated, these modifications may be made to the present disclosure in light of the foregoing description of illustrated embodiments.

Thus, while the present disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope of the disclosure. Therefore, many modifications may be made to adapt a particular situation or material to the essential scope of the present disclosure. It is intended that the disclosure not be limited to the particular terms used in following claims and/or to the particular embodiment disclosed as the best mode contemplated for carrying out this disclosure, but that the disclosure will include any and all embodiments and equivalents falling within the scope of the appended claims.

What is claimed is:

1. A transcoding system, comprising:
a memory encoded with logic; and
a processor configured to execute the logic to, dependent on a defined operation of the system, either perform a first set of steps of a motion estimation operation using one or more reference pictures of a picture sequence input to a compression engine of the system, or perform the first set of steps of the motion estimation operation using one or more decompressed versions of the inputted picture sequence.

2. The system of claim 1, wherein the defined operation comprises a transcoding operation.

3. The system of claim 1, wherein the defined operation comprises transcoding to a bit rate below a threshold bit rate.

4. The system of claim 1, wherein the defined operation comprises transcoding to a bit rate above a threshold bit rate.

5. The system of claim 1, wherein the defined operation comprises transcoding based on a number of bits in a compressed reference picture of the one or more reference pictures received at the input to the compression engine.

6. The system of claim 1, wherein the defined operation comprises transcoding to one of a plurality of bit rates, the one of the plurality of bit rates selected based on a picture type of the one or more reference picture received at the input to the compression engine.

7. The system of claim 1, wherein the defined operation comprises transcoding to one of a plurality of bit rates, one of the plurality of bit rates selected based on a respective portion of the one or more reference pictures in a GOP received at the input to the compression engine being previously compressed at a bit-rate below a respective threshold that corresponds to the picture resolution of the pictures.

8. The system of claim 1, wherein the defined operation comprises transcoding to one of a plurality of bit rates, the one of the plurality of bit rates selected based on a respective quantization value used for the one or more reference pictures received at the input to the compression engine.

9. A method, comprising:
receiving at a compression engine of a transcoding system a picture sequence of a video stream and auxiliary information corresponding to the picture sequence; and
performing the block prediction from one or more reference pictures of the picture sequence based on luma information, in the absence of chroma information, of the one or more reference pictures if the auxiliary information comprises a first value, otherwise performing the block prediction based on the chroma and luma information.

10. The method of claim 9, wherein performing the block prediction based on the chroma and luma information is responsive to the auxiliary information comprising a second value, the second value indicating that the picture sequence was previously encoded at least once.

11. The method of claim 9, wherein performing the block prediction based on the chroma and luma information is responsive to the auxiliary information comprising a second value, the second value indicating that the picture sequence was previously encoded plural times.

12. The method of claim 9, wherein performing the block prediction based on the chroma and luma information is responsive to the auxiliary information comprising a second value, the auxiliary information comprising second information, or a combination of both, wherein the second value indicates that the picture sequence was previously encoded and the second information indicates an expected amount of degradation the picture sequence had previously endured.

13. The method of claim 9, further comprising implementing a first set of encoding tools among a plurality of encoding tools, the first set providing improved compression performance and picture quality retention compared to the other set of the encoding tools among the plurality of encoding tools.

14. The method of claim 9, wherein performing the block prediction is further based on relative input bit-rate or threshold input bit rate.

15. The method of claim 9, wherein performing the block prediction is further based on relative output bit-rate or threshold output bit rate.

16. The method of claim 9, wherein performing the block prediction is further based on a prior compression format of the picture sequence and a compression format to be applied by the compression engine.

17. The method of claim 9, wherein the block prediction comprises spatial prediction, temporal prediction, or a combination of both.

18. The method of claim 9, wherein the transcoding system further comprises a decoder, further comprising passing additional information between the decoder and the encoder during decoding.

19. A transcoding system, comprising:
a decoder; and
a compression engine configured to perform one or more phases of block prediction based on either an inputted version of a reference picture or a decompressed version of the reference picture, the choice of which version to use based on whether auxiliary information conveys that the picture sequence associated with the reference picture has been previously compressed.

20. The system of claim 19, wherein the compression engine is further configured to perform the one or more phases of block prediction based on luma information without chroma information or a combination of the luma and chroma information, the choice of using the luma only or the chroma and luma based on the auxiliary information.
